(19) United States
(12) Patent Application Publication
(10) Pub. No.: US 2015/0017613 A1
(43) Pub. Date: Jan. 15, 2015

(54) INTEGRATED HEALTH MEASUREMENT AND FOOD SERVICE SYSTEM

(71) Applicant: Lee Weinstein, Arlington, MA (US)

(72) Inventors: Yi Song, West Roxbury, MA (US); Lee Weinstein, Arlington, MA (US)

(21) Appl. No.: 14/230,670

(22) Filed: Mar. 31, 2014

Related U.S. Application Data
(60) Provisional application No. 61/810,110, filed on Jul. 9, 2013.

(51) Int. Cl. G09B 19/00; G09B 5/02

(52) U.S. Cl. CPC G09B 19/0092; G09B 5/02
USPC 434/127

(57) ABSTRACT

An infrared imaging service combined with a food service business serves to educate consumers about healthy eating and health in general, and provides viral marketing aspects to grow the food service business and associated healthcare practices. Customers at the food service business may scan a QR code located at a table or food counter, schedule a thermographic image on their smartphone, use an image downloaded to their smartphone ad a ticket to have their thermographic image taken, and be automatically e-mailed their thermographic image when it is taken.

### RELATED PATENT APPLICATIONS

This patent application claims the benefit of U.S. provisional patent application No. 61/810,110, filed Apr. 9, 2013.

### FIELD OF THE INVENTION

The field of the invention relates to health diagnosis, medical measurement, infrared imaging, and more specifically to integrating health and medical measurement systems with food service establishments.

### BACKGROUND OF THE INVENTION

Over the last 50 years, consumers in the US have steadily trended toward eating in restaurants (including fast-food restaurants) more, and eating at home less. Documentary movies such as “Super Size Me”, “Killer At Large”, “Food Inc.”, “Forks over Knives”, and “King Corn” document how health is compromised by big business and its advertising, both in the realm of food technology, food production, and food service.

There is a need to make available to consumers enjoyable, interesting ways to learn about healthy eating and to develop healthy eating habits and health awareness.

Consumers have long known that weight, blood pressure, heart rate, and cholesterol level are indications of health. All of these measurements require contact, and one requires an invasive procedure. There is a need for more non-invasive, non-contact ways for consumers to conveniently receive indications of their health.

In recent years, medical professionals experimenting with infrared thermal imaging have begun to note the influence of various health conditions (for instance tumors or hypertension) on the thermal image of the body of the person with the health condition. Calibrated infrared imaging cameras capable of producing a color-mapped-temperature image at resolutions of 620×480 pixels have become commercially available. Some models such as the NEC TH9260 even come with software which can automatically extend the number of pixels of the image in one dimension by synthesizing multiple images (acquired while the user pans the camera) into a single image, although this feature as implemented tends to produce noticeable flaws in the final image.

Within this document, the terms thermograph, thermographic image, infrared image, thermal image, and infrared thermal image are used interchangeably.

### SUMMARY OF THE INVENTION

It is an object of the present invention to increase the curiosity of consumers regarding their health, ways they can measure and track their health, and ways they can promote good health through what they eat. It is a further object of the present invention to make available to consumers enjoyable, convenient, interesting ways to learn about healthy eating and to develop healthy eating habits and health awareness. It is a further object of the present invention to engage consumers more deeply in health issues by fostering community which engages in health-oriented discussions, games, and the like. It is a further object of the present invention to provide higher quality stitched infrared images from multiple infrared images. It is a further object of the present invention to facilitate the marketing of restaurants that provide healthy food. It is a further object of the present invention to educate (regarding health services) persons who attend a restaurant. It is a further object to provide marketing synergy between restaurants and healthcare establishments.

In one aspect, a preferred embodiment of the present invention combines infrared thermal imaging with food service, enabling consumers to have normally exposed areas of their bodies (for instance face, neck, and hands) thermally imaged before and after a meal. Comparing the results of this non-invasive, non-contact measurement before and after a meal gives consumers the opportunity to see the bodily effects of different foods that they eat. In a preferred embodiment of the present invention, consumers may also elect to go into a private imaging booth or exam room, disrobe, and have a thermal image taken of their entire body.

In a preferred embodiment, consumers may also receive nutrition counseling as an optional service where they dine. This counseling may include advice on nutritional value and/or health detriment of various foods or meals. In a preferred embodiment, this advice may include which meals at other restaurants are preferable over which other meals.

In a preferred embodiment of the present invention, health-related data acquired by hardware aspects of the present invention is made easily sharable through websites such as Facebook, through software interfaces of the present invention. A preferred embodiment includes free consumer-downloadable aps for Droid and Apple smartphone operating systems, as well as establishment-specific smartphone-optimized websites that allow consumers to watch educational videos, schedule infrared scans and health-related services, and make and download infrared images of themselves.

In a preferred embodiment of the present invention, consumers may opt to have health-related data acquired by hardware aspects of the present invention stored in a database module that is part of the present invention. In an alternate preferred embodiment, consumers may choose to store health-related data from the present invention on a personal mobile device such as a smart phone.

In another aspect, the present invention provides multiple stages of possible consumer interaction and participation, to progressively engage consumers' curiosity and foster further learning and benefit. In a preferred embodiment, a first stage includes thermal imaging of face and neck (before and after a meal), a second stage includes full-body thermal imaging and/or herbal or nutritional consultation. Further integrated services which are aspects of alternate preferred embodiment include co-located health services such as acupuncture, chiropractic, massage, etc..

In another aspect, the present invention provides means for consumers to post thermal images of themselves to web-based accounts such as Facebook, Twitter, and the like. In a preferred embodiment, thermal images posted to Twitter are hosted within a database in the present invention, and assigned short URLs that can be posted to Twitter. The web-posting aspects of the present invention serve to magnify the viral spread of information and health-consciousness provided by the present invention.

In another aspect, the present invention provides higher quality stitched infrared images from multiple images acquired during a panning operation of a digital imaging device, by changing the panning method from rotation about an axis to translation along an axis. In a preferred a stitched infrared image is synthesized from a sequence of infrared images taken as an infrared imaging unit is robotically moved in steps along the axis of the photograph to be stitched. For instance, if the original images form the infrared imaging array are 620 pixels wide and 480 pixels high, a stitched image 620 pixels wide and 880 pixels high is synthesized from two images where the camera was vertically moved (is the subject is standing) or horizontally moved (if the subject is lying on an exam table) between the two images by a distance such that the subject moved in the image frame by 400 pixels. This leaves 80 pixels of overlap between the two photos to be stitched, which is sufficient for public-domain stitching software such as hugin to produce an excellent stitched image.

In a preferred embodiment of the present invention, whole-body thermal images are generated by standing the person to be imaged in front of a thermal imaging camera which is mounted on a robotic mount which translates vertically from top to bottom or bottom to top, taking sequential photos with sufficient overlap to allow for good stitching. In a preferred embodiment, stitching reference point targets are included within the area being photographed, such that the targets are at opposite ends of sequentially stitched photos.

In a preferred embodiment of the present invention, the viral social media aspect of the combined dining and health measurements provided in one aspect of the present invention are used as a marketing tool to grow an associated healthcare business such as an acupuncture business, a chiropractic business, a massage business, a nutrition counseling business, an herbalist business, or some combination of these and/or other healthcare practitioner businesses.

In a preferred embodiment, a customer of a restaurant utilizing the present invention sees a small display showing an example thermal at his or her table, and scans a QR code on that display to bring up an explanation on his or her smartphone. The explanation encourages the customer to sign up for a free account and get a free thermal image done of himself or herself. After signup, the customer is given access to a scheduling interface to schedule the free scan within the next 10 minutes. After the customer schedules the scan, a reminder timer starts that alerts the customer on his or her smartphone when it is time to have the scan done. The customer than goes to the scanning camera, places the e-ticket for the scan (which as been sent to the smartphone) on a reader, and the scan interface is automatically enabled. The customer sees himself/herself on a computer monitor and when ready presses a button which initiates the thermal scan. The customer is then immediately automatically e-mailed a regular photo and the equivalent thermographic image.

In a preferred embodiment the customer is later automatically e-mailed an invitation to come back to the restaurant and have “before & after” thermographic images done, before and after consuming a particular health food or drink. This brings the customer back to the restaurant and further engages the customer in learning about healthy eating.

In a preferred embodiment, after having visited the restaurant a having “before & after” thermographic images taken, the customer is automatically e-mailed an invitation to sign up for a health consultation and full-body thermographic image.

### BRIEF DESCRIPTION OF THE DRAWINGS

FIG. 1 is a block diagram of the elements of a preferred embodiment of the present invention.

### DETAILED DESCRIPTIONS OF SOME PREFERRED EMBODIMENTS

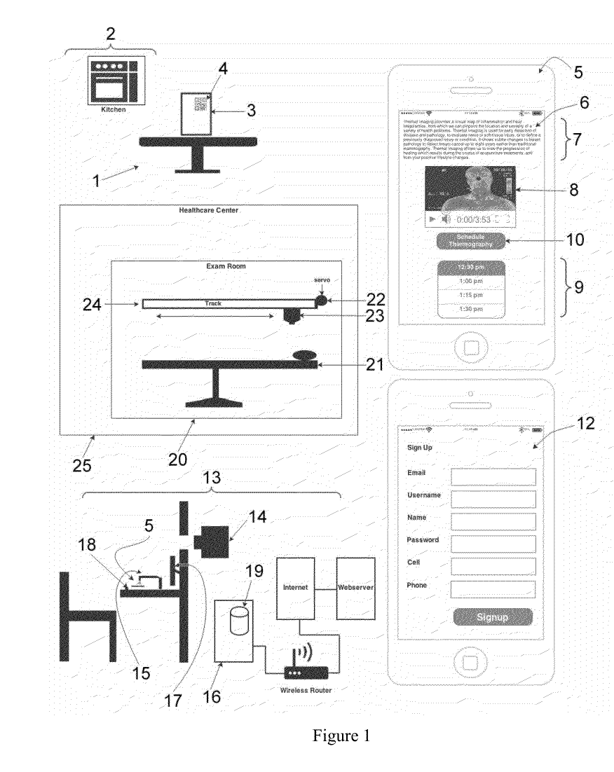

FIG. 1 is a block diagram of the elements of a preferred embodiment of the present invention. A preferred embodiment of the present invention incorporates means for serving a customer food, including food service table/counter 1, and food storage and/or preparation area 2. Food service table/counter 1 further incorporates thermography information display 3, which in a preferred embodiment incorporates smartphone-scannable QR code 4.

When a customer scans QR code 3 with smartphone 5, mobile-optimized scheduling web page 6 is displayed. Mobile-optimized scheduling web page 6 includes introductory text 7 and video 8 which educate the customer about thermography. mobile-optimized web page 6 also incorporates scheduling interface 9 that allows the customer to schedule a thermography photo.

In a preferred embodiment, when scheduling button 10 is clicked by the user, the user's browser cookies are automatically checked by web server 11 to see if the user's identifying information is known. If it is not known, user registration web page 11 is shown automatically and the user is informed that he/she must sign up in order to complete the thermograph scheduling process.

In a preferred embodiment, registration requires the user to enter username and e-mail address, and also asks for mobile phone number to alert user just prior to the user's scheduled thermograph time. After the user completes the registration process (or immediately after the user presses thermograph scheduling button 10 if the user has previously registered), another web page containing a ID data (for instance in the form of a QR code) is displayed automatically, and the user is informed that this page is his/her ticket for his/her thermograph.

In a preferred embodiment, when the user's schedule thermograph time is near, the user is alerted (for instance through a cell phone ap, web timer, call or text message to the user's cell phone) that it is time to have his/her thermograph done. The user then proceeds (with his/her cell phone) to thermography booth 13.

Once seated in thermography booth 13 facing thermography camera 14, the user places his/her cell phone in code reader 15, and computer 16 optically reads the identifying data form the user's cell phone screen through reader 15, and automatically verifies that the user is currently scheduled for a thermograph. Provided the user is so scheduled, computer 16 turns on combined visible-light camera & thermograph camera 14, and displays a visible-light image of said user on video display 17, along with instructions telling the user to adjust his/her expression and posture as he/she desires for the photo/thermograph, and press take-photo button 18.

Once the user presses take-photo button 18, the user's photo and thermograph are displayed on screen 17, stored in database 19, and immediately e-mailed to the user attached to an e-mail that invites the user to share the thermograph with friends via social media. A preferred embodiment also allows the thermographic image of the user to be printed (for instance on photographic paper or by a color laser printer) and given to or sold to the user. A preferred embodiment of the present invention may be configured such that the user is automatically informed (for instance via e-mail) that he/she may log into his/her account to download the photo, or use semi-automated interfaces to post the photo to social media such as Facebook or Twitter.

In a preferred embodiment, future e-mails are automatically sent to the user, inviting the user to have thermographs taken at a future visit before and after drinking or eating a particular beverage or food. In a preferred embodiment, future e-mails are also sent to the user inviting the user to engage in a health consultation such as a a nutrition consultation, acupuncture consultation, massage consultation, full-body thermography, herbal consultation, chiropractic consultation, or a consultation that may recommend any one or more such consultations or healthcare services.

A preferred embodiment of the present invention includes a healthcare facility 25, co-located with the food service establishment described above. In a preferred embodiment, healthcare facility 25 includes exam room 20, in which a patient may lie on seam table 21 to have a thermographic image taken by thermographic camera 23, which may be moved along track 24 in one or two Cartesian dimensions under computer control by robotic servo-drive 22.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. An integrated health measurement and food service system, comprising:
Means for serving customers food;
Means for acquiring an infrared image of a portion of a customer not covered by clothing;
Means for transferring said infrared image to said customer;

2. The system of claim 1, wherein said means for transferring said image to said customer comprises means for automatically e-mailing said image to said customer.

3. The system of claim 1, wherein said means for transferring said image to said customer comprises means for automatically posting to a web-based account of said customer.

4. The system of claim 1, further comprising database means comprising contact information for a plurality of customers and digital thermal images of said customers.

5. The system of claim 1, wherein said means for acquiring an infrared image are mounted on robotically actuated position translation means capable of translating said means for acquiring an infrared image along at least one Cartesian axis.

6. The system of claim 5, wherein said means for acquiring an infrared image are mounted on robotically actuated position translation means capable of translating said means for acquiring an infrared image along at least two Cartesian axis.

7. A method of doing business, comprising:
Acquiring a first thermal image of a customer prior to serving said customer a meal;
Serving said customer said meal;
Acquiring a second thermal image of said customer after said meal;
Making healthcare recommendations based on the difference between said first thermal image and said second thermal image.

8. A method of doing business comprising:
Providing means for customers at said food service establishment to have infrared images of themselves produced; and
Providing means at said food service establishment to transfer said infrared images to said customers.

9. The method of claim 8, further comprising providing means at said food service establishment for said customers to upload said infrared images in digital form to customer-owned portable electronic devices.

10. The method of claim 8, further comprising means at said food service establishment for said customers to upload said infrared image in digital form to a website.

11. The system of claim 1, further comprising:
Means for serving web page comprising a scheduling interface;
Means for scheduling an event for a person based on identifying information including web cookies;
Means for serving a web page including an electronic ticket to web-connected mobile device based on said identifying information;
Means for optically recognizing said electronic ticket information when it is displayed on the display screen of said web-connected mobile device;
Means for enabling thermographic imaging equipment bases on said optical recognition; and
Means for storing said thermographic image in a database based on identifying information linked to said electronic ticket.
